(19) United States
(12) Patent Application Publication
(10) Pub. No.: US 2012/0160997 A1
(43) Pub. Date: Jun. 28, 2012

(54) Non-radioactive ion sources with ion flow control

(76) Inventors: Richard Lee Fink, Austin, TX (US); Alexei Tikhonski, Cedar Park, TX (US); Leif Thuesen, Round Rock, TX (US); Erkinjon G. Nazarov, Lexington, MA (US); Evgeny V. Krylov, Billerica, MA (US); Raanan A. Miller, Chestnut Hill, MA (US)

(21) Appl. No.: 12/284,323

(22) Filed: Sep. 19, 2008

Related U.S. Application Data
(60) Provisional application No. 60/994,701, filed on Sep. 21, 2007.
(60) Provisional application No. 61/082,414, filed on Jul. 21, 2008.

(51) Int. Cl. H01J 49/26; H01J 27/02; H01J 49/04; B82Y 99/00

(52) U.S. Cl. 250/282; 250/288; 250/423 R; 977/742

(57) ABSTRACT

An ion-based analyzer including a non-radioactive ion source, an ion generation chamber for generating ions, a sample ionization chamber and a controller for employing ion flow control, an ion-based filter, and a detector for analyzing a sample.

### REFERENCE TO RELATED APPLICATIONS

This application claims the benefit of and priority to: U.S. Provisional Application No. 60/994,701, filed on Sep. 21, 2007, entitled “Capacitive Gas Discharge Ion Source”; and U.S. Provisional Application No. 61/082414, filed on Jul. 21, 2008, entitled “Non-Radioactive Plasma Ion Source”. The entire contents of the above referenced applications are incorporated herein by reference.

### FIELD OF THE INVENTION

The invention relates to an ion-based analyzer with a non-radioactive ion source, and more particularly, to a non-radioactive ion source employing reverse flow control, which provides appropriate ion chemistry for formation of negative ion species from analytes in ambient conditions.

### BACKGROUND OF THE INVENTION

The creation of ionized particles is a useful tool for many applications, such as for ignition of lasing or to assist chemical analysis, among other uses. In some equipment, high energy radioactive sources of alpha or beta particles are employed for the ionization process. However, because of the potential health hazard and need for regulation, wide-spread use of equipment using radioactive ionization sources has been limited for civilian applications.

Recently, government agencies from the U.S. and other foreign countries have recognized the problem of orphaned radioactive sources worldwide. Such sources pose a security risk in the form of potential material for a “dirty bomb” or other illicit applications. Despite their relatively low power, illicit use of rouge radioactive sources can still cause casualties and contaminate the area surrounding the explosion with radioactive material. This can lead to health risks from radiation sickness and increased cancer rates to those exposed to the radiation directly, or through inhalation or ingestion.

In addition to the use of these materials in a dirty bomb, another concern is that lost or orphaned radiation sources could be inadvertently mixed with other recyclable material. This could result in a general dispersion of the material that would be difficult to follow or detect.

Nuclear sources of radiation that are of concern include:

Cobolt-60—Gamma emitter: Used for cancer treatment and to irradiate food to kill pathogens.

Cesium-137—Beta and Gamma emitter: Used in medical and scientific equipment.

Americium-241—Alpha emitter: Used in smoke detectors and moisture content gauges.

Tritium—Weak Beta emitter: Used for emergency exit signs that glow in the dark.

Iridium-192—Beta and Gamma emitter: Used for detecting flaws in concrete and welding.

Nickel-63—Beta emitter: Used for gas ionization sources for chemical analysis.

There are several ionization methods of ion generation at ambient conditions that avoid radioactive sources. Corona discharge is a source of non-radioactive ionization. It provides high energy in a compact package. However, this process is not stable and can contaminate the sample with metal ions or NOx, which can interfere with analytical results. Furthermore, there is sufficient dependence of the composition of generated ion species upon the applied voltage.

Another ionization process is UV ionization. One disadvantage of UV ionization is that it provides low to moderate ionization energies. This limits the types of molecules that can be ionized. As well, sometimes UV ionization can give unexpected results. The photons are typically generated in a tube, with the photons passing through a window, and this window material affects efficiency. Also, the surfaces of the UV devices can become contaminated or coated from the ionization product, which can degrade device performance or output intensity. As well, the UV tubes can be delicate and fragile, and hence are generally not suitable to operation in harsh environments or in applications requiring a significant amount of manual handling.

Another ionization process is RF discharge ionization. RF discharges are subdivided into inductive and capacitive discharges, differing in the way the discharge is produced.

Inductive methods are based on electromagnetic induction so that the created electric field is a vortex field with closed lines of force. Inductive methods are used for high-power discharges, such as for production of refractory materials, abrasive powders, and the like.

Capacitive gas discharge (CGD) methods are used to maintain RF discharges at moderate pressures p˜1-100 Torr and at low pressures p˜10⁻³−1 Torr. The plasma in them is weakly ionized in a non-equilibrium state, like that of a corona discharge. Moderate-pressure discharges have found application in laser technology to excite CO₂ lasers, while low-pressure discharges are used for ion treatment of materials and in other plasma technologies. Current CGD methods in the art are deficient because they do not allow for source parameter optimization, which leads to poor ionization efficiency and undesirable ion species, including metal ions and NOx. Current non-radioactive negative ion sources are especially susceptible to undesirable ion species such as NOx, that can limit the sensitivity and resolution of an ion analyzer using the ion source.

Accordingly, there is a need to reduce the amount of contamination within a non-radioactive ion source to enhance ion analysis using such sources.

### SUMMARY

The invention, in various embodiments, addresses the deficiencies in the prior art by providing reliable non-radioactive ionization sources for various applications, and includes a method and system for optimizing source parameters through reverse flow control for better ionization efficiency.

In one embodiment of the invention, an ion-based analyzer includes an ion generation chamber with a non-radioactive ion source for generating ions. The ion generation chamber includes a first transport gas inlet for providing a first transport gas flow. In addition, the ion-based analyzer may include a sample ionization chamber with an ion inlet for receiving ions and a sample inlet for receiving a sample. A portion of the sample may be ionized to form sample ions. The sample ionization chamber may include a second transport gas inlet for providing a second transport gas flow. The ion-based analyzer may also include a controller for controlling the flow rate of at least one of the first transport gas flow and the second transport gas flow in order to control the transport gas flow through the ion inlet. In one configuration, controlling the transport gas flow through the ion inlet includes controlling the direction and flow rate of the gas flow through the ion inlet. In one feature, the transport flow through the ion inlet includes a reverse transport flow such that the transport flow substantially opposes the ion flow. In another feature, the ion flow is directed by an electric field. Also, the ion-based analyzer may include an ion-based filter for filtering sample ions, which may be in communication with the sample ionization chamber. The ion-based analyzer may also include a detector for detecting the filtered sample ions.

In one configuration, the controller includes a processor. The transport gas may substantially include an inert gas. In another feature, the transport gas substantially includes air. In another configuration, the ion source includes at least one carbon nanotube. In another configuration, the ion source includes a capacitive gas discharge ion source. In another configuration the ion source may include a cross-wire ion source. The ion source may include a dielectric barrier discharge source. In yet another configuration, the ion source includes an Insulating Barrier Ionizer (IBI) source.

In various implementations, the ion source substantially produces negative ions. In other implementations, the ion source substantially produces positive ions. The ion source may produce both positive and negative ions. The ion-based analyzer assembly may include at least one of a differential mobility spectrometer (DMS), a ion mobility spectrometer (IMS), a mass spectrometer (MS), a ion mobility based filter, and a mass-to-charge based filter.

In another aspect of the invention, analyzing a sample consists of flowing a first transport gas through a transport gas inlet to an ion generation chamber, generating ions in the generation chamber using a non-radioactive ion source, receiving ions in a sample ionization chamber from an ion inlet, receiving a sample in a sample ionization chamber from a sample inlet, ionizing a portion of the sample to form sample ions, flowing a second transport gas through a second transport gas inlet to a sample ionization chamber, controlling the flow rate of at least one or both of the first transport gas flow and the second transport gas flow to control the transport gas flow through the ion inlet, filtering the sample ions using an ion-based filter in communication with the sample ionization chamber, and detecting the filtered sample ions.

In a further aspect, the ion source is made up of a non-radioactive ionizer for generating ions, a first transport gas flow for flowing a portion of the ions toward an ion analyzer, and a second transport gas flow for flowing a second portion of the ions away from the ion analyzer. The ion source may comprise a controller for controlling the adjustable flow rate and the second transport gas flow, and the frequency, duty cycle, RF voltage and power of ionizer operation mode.

### BRIEF DESCRIPTION OF THE DRAWINGS

The foregoing and other objects, features and advantages of the present invention will now be described with respect to the accompanying drawings in which like reference designations refer to like parts throughout the different drawings. The drawings are not necessarily to scale, emphasis instead being placed upon illustrating the principles of the invention in which:

FIG. 1 is a generalized block diagram of an ion based analyzer employing a non-radioactive ion source, an ion-based filter, and a detector according to an illustrative embodiment of the invention.

FIG. 2 shows a diagram of an ion based analyzer including a differential mobility spectrum analyzer according to an illustrative embodiment of the invention.

FIG. 3A shows a block diagram of a system employing a capacitive discharge plasma ionization source according to an illustrative embodiment of the invention.

FIG. 3B shows a block diagram of a RF drive circuit of the type that may be employed in the system of FIG. 3A, according to an illustrative embodiment of the invention.

FIG. 3C shows oscilloscope images displaying AC pulse frequency and pulse repetition rate (duty cycle).

FIG. 4A and 4B show an example of a wire grid ionization source according to an illustrative embodiment of the invention.

FIG. 4C shows an example of a source made up of electrodes placed in dielectric sheaths according to an illustrative embodiment of the invention.

FIG. 4D shows an example of a diverging curved plasma electrode source according to an illustrative embodiment of the invention.

FIG. 5 shows an example of using carbon nanotubes as an ionization source according to an illustrative embodiment of the invention.

FIG. 6A shows a plot of positive and negative spectra from an ionization source that include carbon nanotubes as the field emission structures according to an illustrative embodiment of the invention.

FIG. 6B shows a plot of comparison spectra in which the ionization source utilizes radioactive 63-Ni instead of carbon nanotube field emission structures according to an illustrative embodiment of the invention.

FIG. 7A shows a cross-sectional diagram of an Insulating Barrier Ion source assembly according to an illustrative embodiment of the invention.

FIG. 7B shows another perspective of a diagram of an Insulating Barrier Ion source assembly according to an illustrative embodiment of the invention.

FIG. 8 shows a perspective view of an Insulating Barrier Ion source assembly.

FIG. 9A and 9B show two diagram examples of an Insulating Barrier Ion source coupled with a differential mobility spectrum analyzer according to illustrative embodiments of the invention.

FIG. 9C shows a perspective view of the setup as diagramed in FIG. 9B.

FIG. 9D shows a plot depicting the spectra of a transport gas consisting of N₂, according to an illustrative embodiment of the invention.

FIG. 9E shows a plot depicting the spectra of a transport gas consisting of air, according to an illustrative embodiment of the invention.

FIG. 9F shows a plot depicting the spectra of Methyl Salicylate mixed with a transport gas consisting of N₂, according to an illustrative embodiment of the invention.

FIG. 9G shows a plot depicting the spectra of Methyl Salicylate mixed with a transport gas consisting of air, according to an illustrative embodiment of the invention.

FIG. 10A shows an example of an ion based analyzer employing reverse flow control according to an illustrative embodiment of the invention.

FIG. 10B shows an example of ion based analyzer employing reverse flow control where carbon nanotubes are used as an ion source according to an illustrative embodiment of the invention.

FIG. 11A shows a simulation of ion flow in an ion-based analyzer employing reverse flow control according to an illustrative embodiment of the invention.

FIG. 11B shows two simulations of alternative implementations of an ion-based analyzer employing reverse flow control according to illustrative embodiments of the invention.

FIG. 12 shows an experimental setup where reverse flow is controlled within an ion-based analyzer according to an illustrative embodiment of the invention.

FIG. 13A-13E show plots comparing spectra with varying reverse flow rate according to an illustrative embodiment of the invention.

FIG. 14 shows a plot of negative reactant ion evolution in dependence of reverse flow rate according to an illustrative embodiment of the invention.

### DESCRIPTION

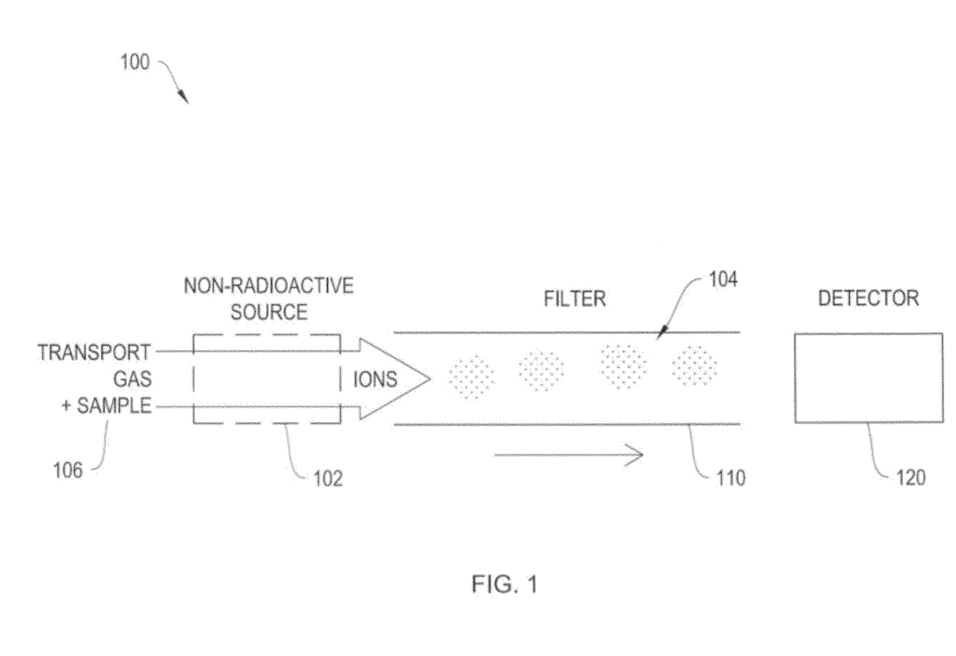

FIG. 1 is a generalized block diagram of an ion based analyzer employing a non-radioactive ion source, an ion-based filter, and a detector according to an illustrative embodiment of the invention. In FIG. 1, a transport gas and a sample 106 may be passed through a non-radioactive ionization source 102. The non-radioactive ionization source ionizes at least a portion of the sample into sample ions 104 which may be filtered by filter 110. In one embodiment, the ions 104 are passed by filter 110 and are received at a detector 120. Detection of the ions 104 at the detector 120 results in a small (e.g., pico amps, pA) amount of current that is then amplified by, for example, by a transimpedance amplifier. The transimpedance amplifier may include, for example, a feedback resistance element of tens to hundreds of mega ohms (Mohms). Thus, the small current is amplified to a voltage range that can be interpreted by a processor, such as a digital signal processor (DSP) or microprocessor and utilized for analysis purposes.

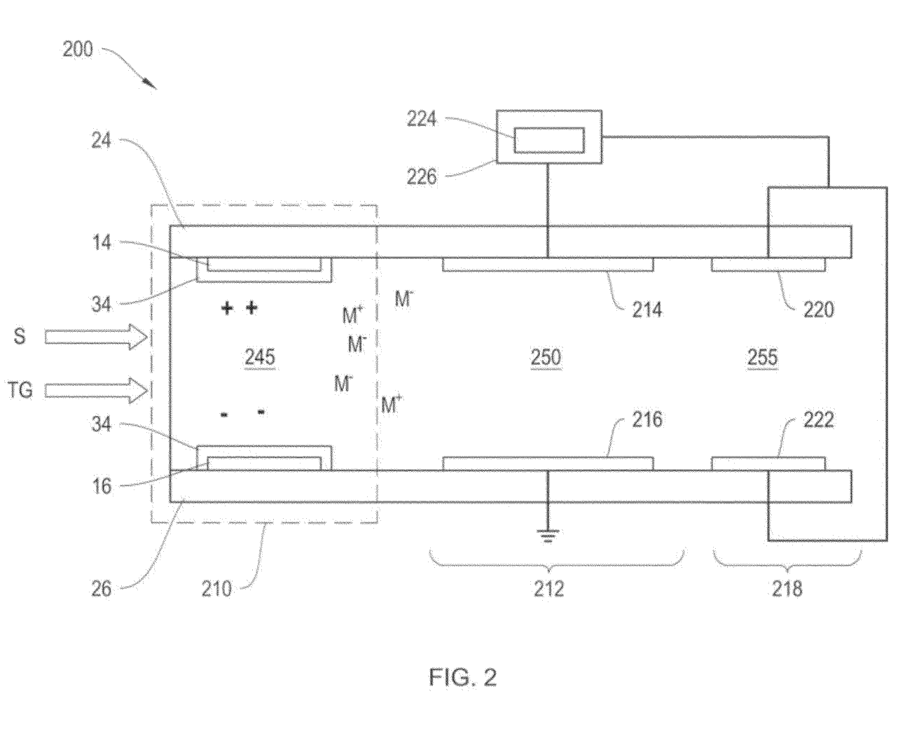

FIG. 2 shows a diagram of an ion based analyzer including a differential mobility spectrum (DMS) analyzer according to an illustrative embodiment of the invention. A DMS may also be referred to as a Field Asymmetric Ion Mobility Spectrometer (FAIMS). The DMS analyzer is an example of one of many types of filter 110 and detector 120 components that may be used in an ion-based analyzer system. Other filter 110 and detector components of an ion-based analyzer system may include an ion mobility spectrometer (IMS), as mass spectrometer (MS), an ion mobility based filter and a mass-to-charge based filter. In particular, FIG. 2 depicts a DMS system 200 having an ionization device 210 upstream for plasma ionization. Ions are generated for chemical analysis of a sample S in a transport gas (or carrier gas) TG.

More particularly, the system 200 of FIG. 2 includes an ionization source 210, an ion filter 212 in the filter region 250 defined between filter electrodes 214 and 216, and a detector 218 in a detection region 255 between detector electrodes 220 and 222. Asymmetric field and compensation bias signals or voltages are applied to the filter electrodes 214 and 126 by a drive circuit 224 within a control unit 226. The detector electrodes 220 and 222 are also under the direction of the drive circuit 224 and the control unit 226.

Briefly, in operation, the carrier gas CG, is ionized in the plasma region 245 forming ions ++,−− and the sample S is ionized creating both positive and negative ions, M⁺and M⁻. Based on DMS ion filtering techniques, only certain ion species pass through the filter region 250, while others are filtered out (i.e., they are neutralized by contact with the filter electrodes 214 and 216). Those that pass through are detected at the detector electrodes 220, 222. Preferred DMS configurations are described in greater detail in U.S. Pat. Nos. 6,495,823 and 6,512,224, the entire contents of both of which are incorporated herein by reference.

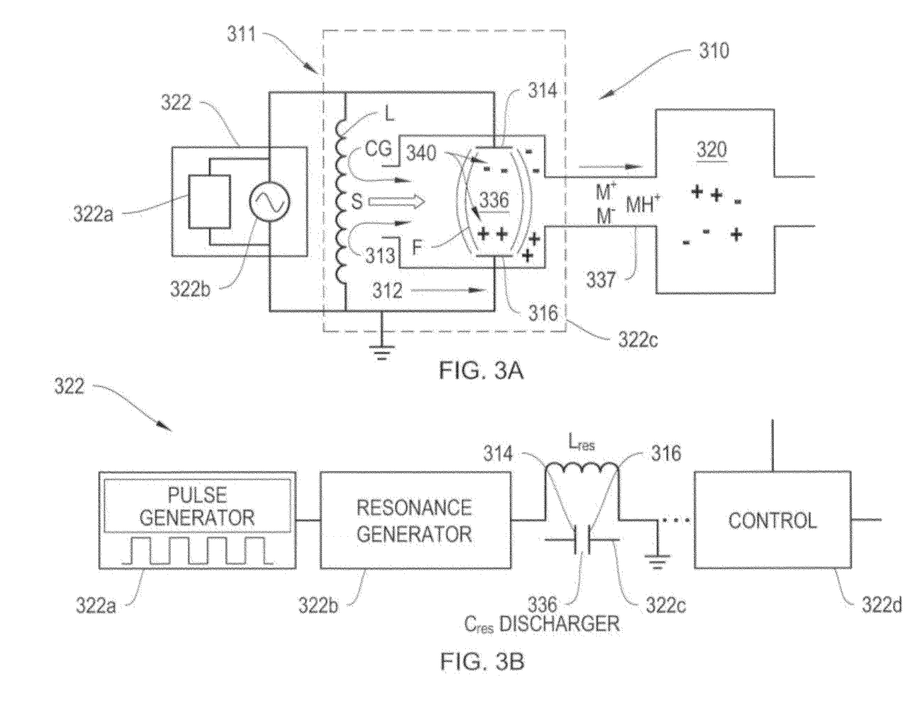

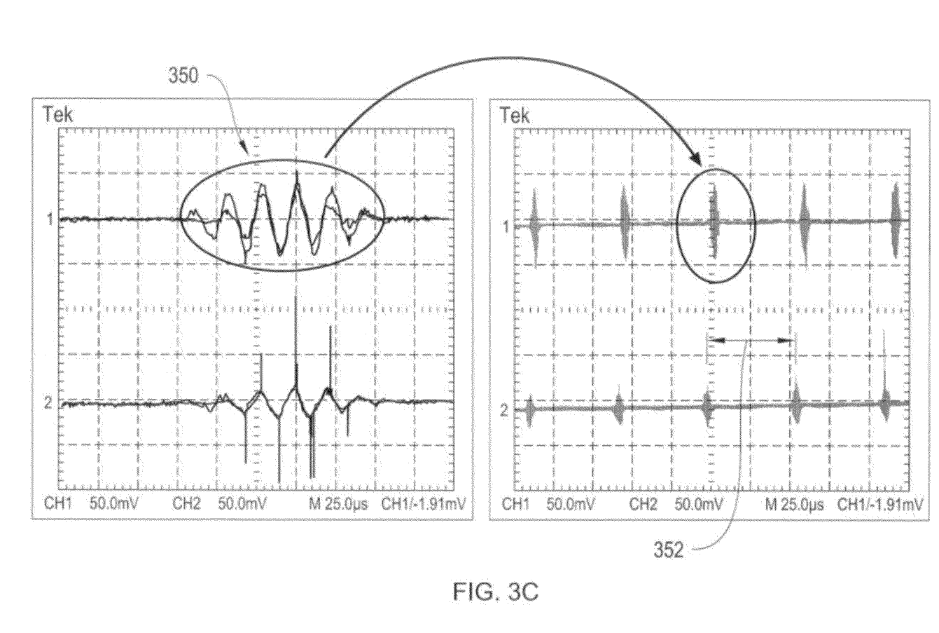

FIG. 3A shows a block diagram of a system employing a capacitive gas discharge (CGD) plasma ionization source according to an illustrative embodiment of the invention. The CGD ionization source is one example of a non-radioactive ion source 102 as described in FIG. 1. In one embodiment of FIG. 3A, a carrier gas CG (also referred to as a transport gas) and sample S are fed through an inlet 313 into a plasma ionization region 336. The transport gas is ionized by capacitive discharge between the electrodes 314 and 316. This discharge process produces a plasma 340, which ionizes the gas CG and the sample S with both positive and negative ions, M⁺, MH⁺, and M⁻, and illustratively generates (H2O)ₙ, H⁺, O⁻, O₂⁻, O₃⁻, (NₓO^{y})⁻(H₂O)ₙ.

The generated ions in the ionization region 336 exit through a passage 337 for further downstream utilization. In an analytical embodiment of the invention, these ions proceed from the passage 337 into the spectrometer 320 for analysis, as shown in FIG. 2.

FIG. 3A shows an illustrative control and drive circuit 322. The control and drive circuit 324 is depicted in more detail in FIG. 3B. As shown, the illustrative circuit 322 includes a pulse generator 322a, a resonance generator 322b, and a resonant circuit 322c. The resonant circuit 322c includes the electrodes 314 and 316 spaced by an ionization gap G and an inductor L. A microchip or other logic or controller device 322d may also be supplied in communication with drive circuit 322, and optionally may include inputs from other system feedback or data sources, to affect total system control. The control and drive circuit 322 may be driven using known techniques. The control and drive circuit 322 may also employ an optimization routine for selecting operating conditions based on the above mentioned system inputs.

FIG. 3C shows oscilloscope images displaying AC pulse frequency 350 and pulse repetition rate (duty cycle) 352. All configurations of ionizers require a high voltage AC driver. FIG. 3C shows an oscilloscope trace with a waveform for an AC driving voltage. The power input to the ionizer can be adjusted by changing the frequency of the AC pulse 350 or the pulse repetition rate 352.

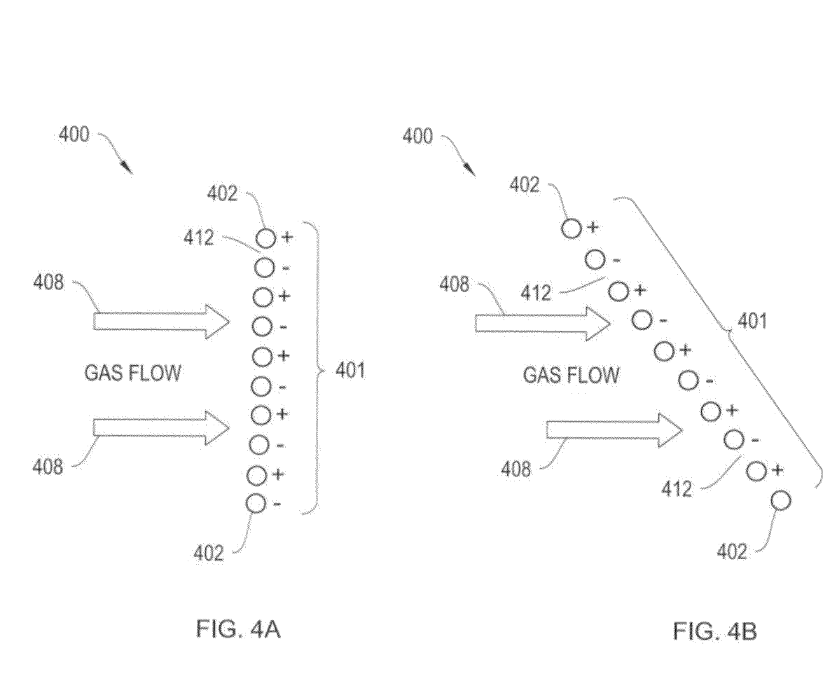

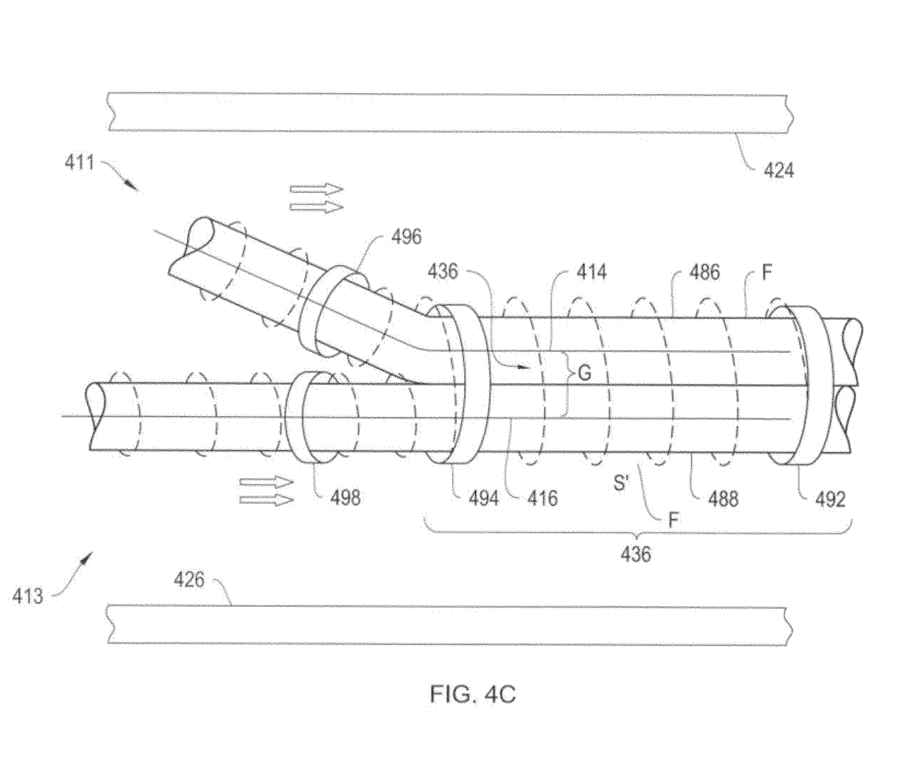

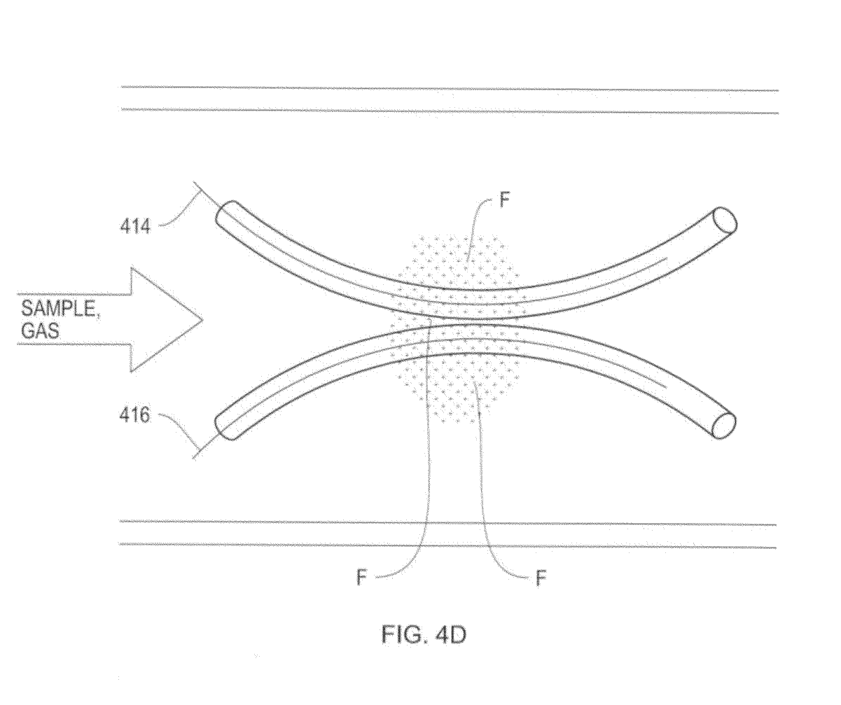

FIGS. 4A and 4B show an example of a wire-grid ionization source according to an illustrative embodiment of the invention. A wire-grid ionization source is another example of an ionization source 102 that can be implemented in the ion-based analysis system 100 of FIG. 1. FIG. 4A illustrates a cross-section of a single wire grid 401 on which electron field emission structures are formed. In one implementation of FIG. 4A, the wire grid 401 may be formed of metal wires or insulators that are covered with a conductive coating. The wires 402 of the grid are separated by openings 412. The surface of the wire grid 401 is coated with field emission structures (not shown) such as carbon nanotubes. A gas flow 408 is provided that passes through the openings 412 in the wire grid 401. A voltage is applied to the wire grid 401 in an alternating manner such that each wire in the grid 401 has an opposite polarity from an adjacent wire. As the gas flows between the grid openings 412, the gas molecules become ionized by the electrons emitted from the field emission structures. Once formed, the ions do not experience significant drift due to the applied electric field between wires 402. However, because of the smaller area in which ionization occurs, fewer ions may be formed. The gas flow does not need to travel perpendicular to the openings but also may enter the openings 412 at oblique angles as shown in FIG. 4B.

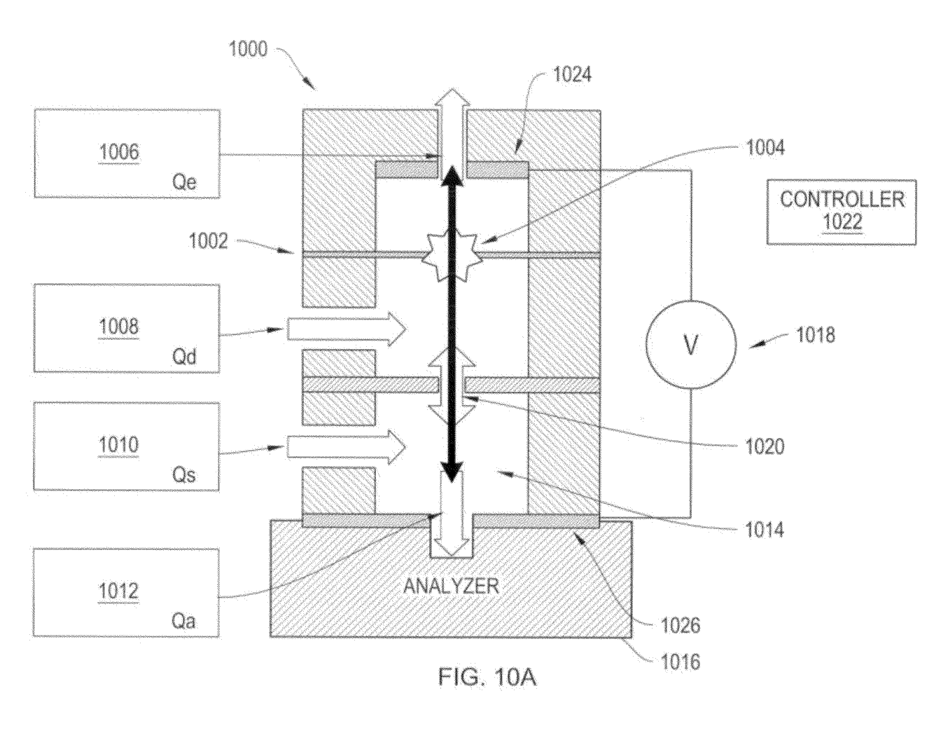

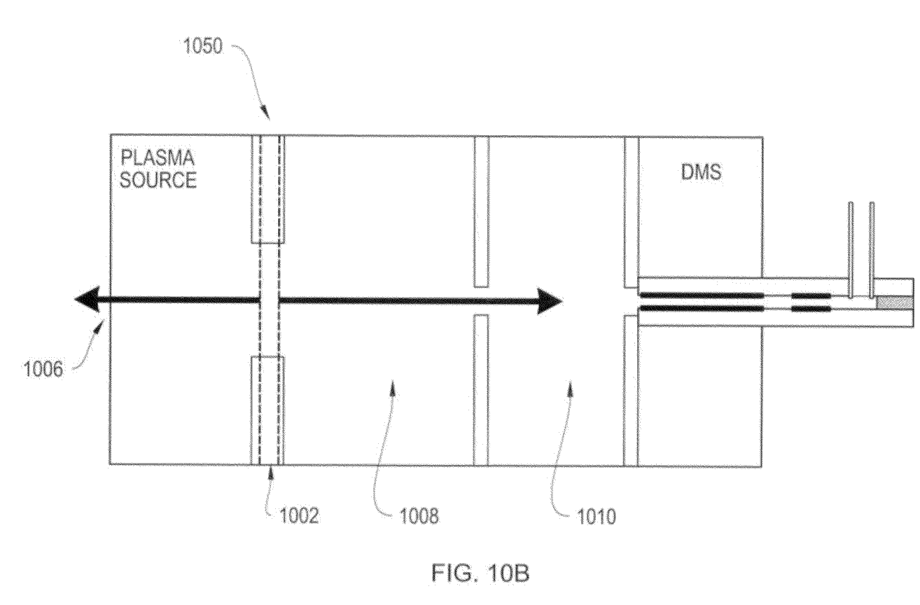

FIG. 4C shows an example of a source made up of electrodes placed in dielectric sheaths according to an illustrative embodiment of the invention. In FIG. 4C, conducting electrodes 414 and 416 are placed into adjacent tube-like dielectric sheaths 486 and 488, formed from, for example, glass, quartz, ceramic or other suitable material. Preferably, the dielectric sheaths 486 and 488 are fixtured so that the separation between the electrodes 414 and 416 is fixed with the ionization region 436. This separation can range, for example, from having the dielectric sheaths 486 and 488 touching to having a separation of about 5 mm or more. As shown in FIG. 10, the electrodes 414 and 416 may be held and joined via collars 492 and 494. Just beyond the collar 494, the ionization region is effectively terminated after the electrodes 414 and 416 diverge. This arrangement allows the ability to define the length of the ionization region, and thus provides predictable performance characteristics. The abutting collars 496 and 498 are affixed on each of the tubes 486 and 488 after the collar 494 to fix the divergence. In various illustrative embodiments, the electrodes 414 and 416 may be formed to conventional thin wire filaments and may be contained in a tube or coated with a dielectric or other insulating material.

FIG. 4D shows an example of a diverging curved plasma electrode source according to an illustrative embodiment of the invention. In this embodiment, the field F is formed between diverging electrodes 414 and 416. In other illustrative embodiments, the plasma electrodes 414 and 416 may be, for example, parallel or parallel or angled relative to each other, be relatively straight or curved, have relatively smooth or textured inner and outer surfaces, or any combination of the above. The electrodes 414 and 416 are separated by a gap, whether exposed or isolated, embedded in a dielectric material, or within isolating tubes, and may be parallel or diverging. Additionally, the electrode diameter and isolation coating material type and diameter/thickness may be selected such that the fields generated between the electrodes 414 and 416 are accessible to the gas flow.

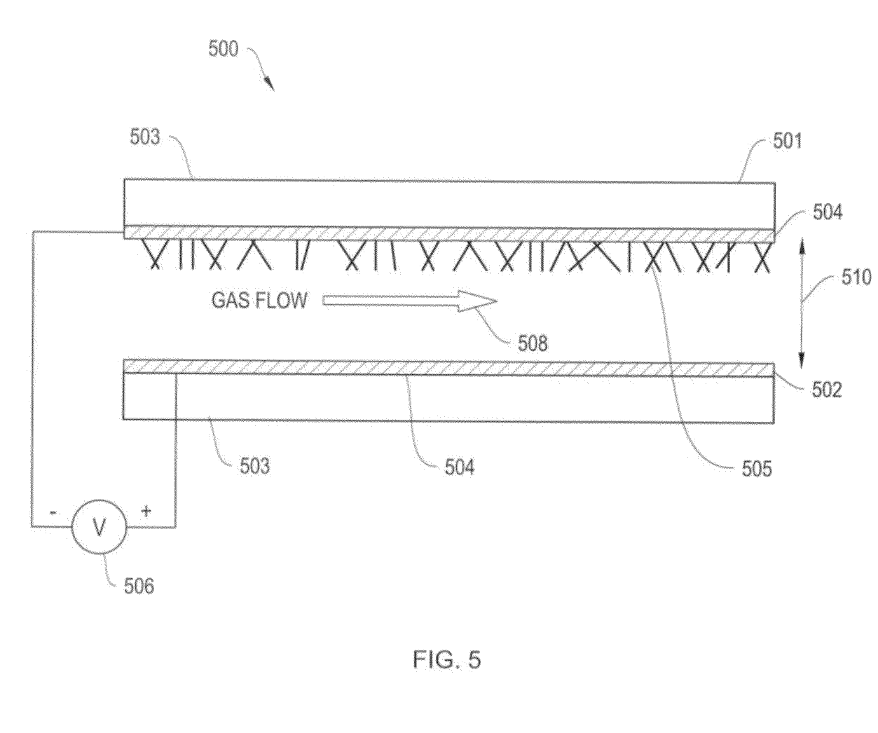

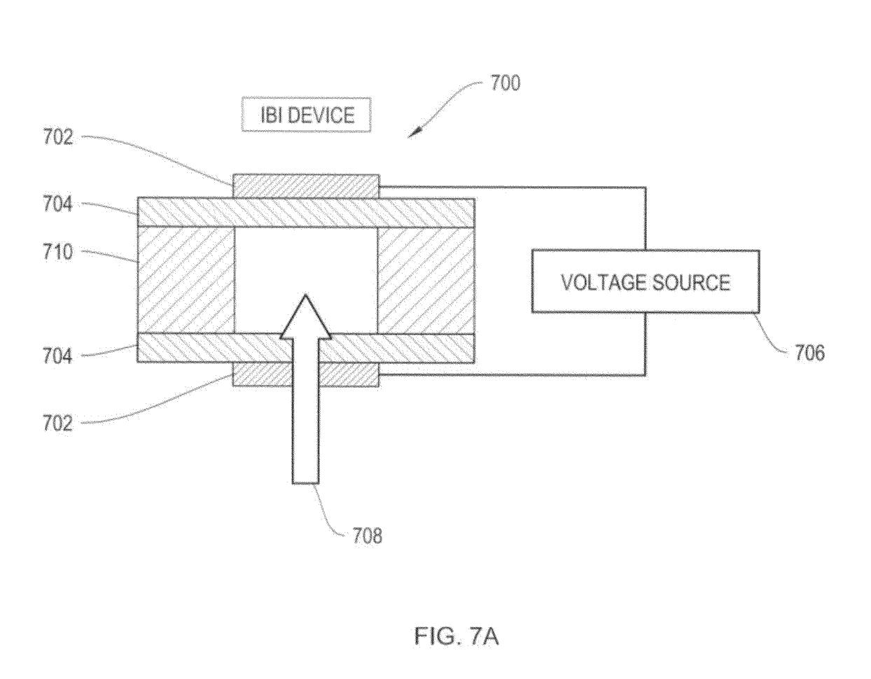

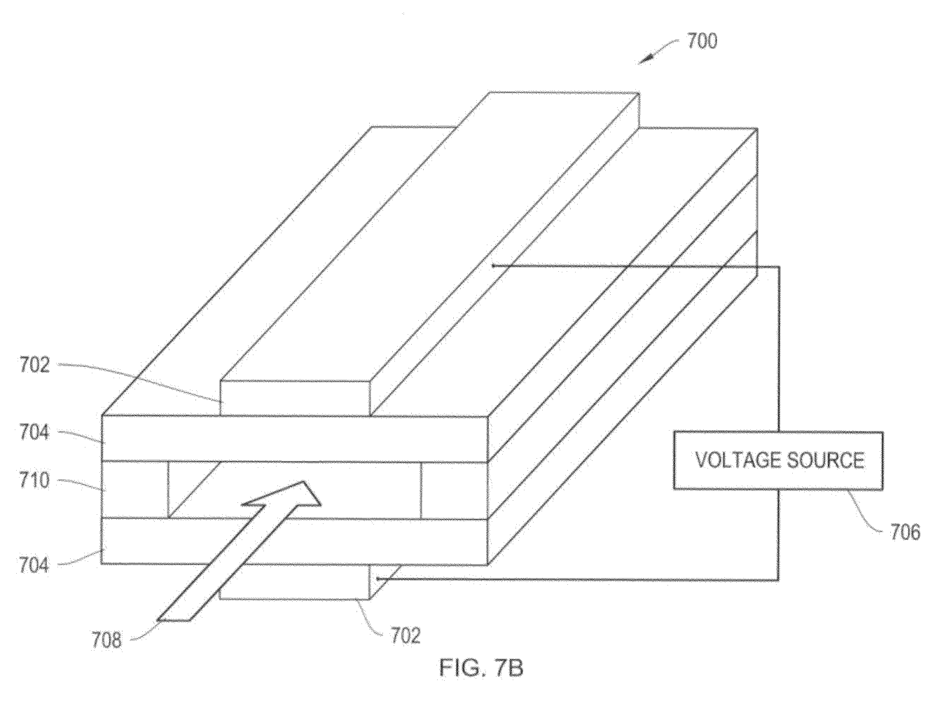

FIG. 5 shows an example of using carbon nanotubes as an ionization source according to an illustrative embodiment of the invention. A carbon nanotube (CNT) ionization source is another example of an ionization source 102 that can be implemented in the ion-based analysis system 100 of FIG. 1. An example of using field emission structures to produce ionized gas molecules is illustrated in FIG. 5. An ionization device 500 includes two conductor plates 501, 502. The plates are separated by a gap 510 having a height d that ranges from 50-10,000 microns and a width w (extending into the page). Spacers to maintain the gap and to channel the air flow are not shown but would look similar to parts 710 in FIG. 7A and 7B. The conductor plates may comprise a conductor material or a conductor-coated insulator such as, for example, metal-coated glass or ceramic panels. In the example shown in FIG. 5, each of the conductor plates includes an insulator 503 and a conductive coating 504. The conductive coating 504 may be formed using fabrication techniques such as electron-beam deposition, sputtering or chemical vapor deposition. Other techniques for forming the coating 504 may be used as well.

One of the conductor plates 501 is also coated with micro or nano-structures that serve as electron field emission structures 505. The surface of the other conductor plate 502 may be relatively smooth. The field emission structures 505 include, but are not limited to, single-walled or multi-walled carbon nanotubes (including double wall), nanowires and microtips. The nanowires and microtips may be formed of a conducting material, such as metal, or semiconducting material, such as silicon. The field emission structures 505 may be formed using chemical vapor deposition or printed using inks or pastes. The aspect ratio for the micro and nano structures ranges from 10-10,000 (typically 100-1000). The field emission structures may be vertically aligned, as shown in FIG. 5. A potential source 506, such as a battery or power supply, is applied across the conductor plates 501, 502. Gas flow 508 provides the gas molecules to be ionized by the field emission structures 505. The flow of gas may occur at atmospheric pressure or very close to atmospheric pressure, although the ionization source may be operated under sub-atmospheric conditions as well. In some cases, both conductors 501, 502 are coated with field emission structures 505.

Ionization device 500 is operated with the field emission structures 505 biased negatively by the power source 506. At sufficiently high bias, the negative bias induces electrons to quantum mechanically tunnel from the field emission structures 505 into the gas environment located between the conductor plates 501, 502. The extracted electrons accelerate due to the applied electric field that exists across the plates. As a result, the electrons gain kinetic energy. The applied electric field may alternatively be provided by an AC field, a DC field or simultaneous application of both AC and DC fields. When an AC field is used, electron emission may occur for only a portion of the time that the field is applied. In some cases, the electrons will collide with the gas molecules flowing through the device 500. When low voltages are used, the electrons do not experience strong acceleration and thus enable a “soft” plasma to form in the gap between the conductor plates such that ion chemistry is avoided. Accordingly, there is no danger of a corona discharge occurring or of cracking molecules that are of interest for gas ionizers. If the kinetic energy of the electrons is smaller than the ionization potential of the gas molecules, the electrons may be captured by the molecules (thus forming negative ions). For example, in the case of oxygen molecules (which have an electron affinity equal to 0.5 eV) passing through the device 500, the electrons may be captured to form negative oxygen ions. Alternatively, the electrons may pass through the gap 510 to the conductor plate 502.

If the applied voltage is increased, the electrons may gain enough kinetic energy such that, upon collision with the gas molecules, positive ions and secondary electrons are formed. This is known as electron impact ionization. However, at the interface close to the field emission structures 505, most electrons will not have gained enough kinetic energy for impact ionization, such that electron capture is the main process by which ionization occurs. Further from the field emission structure 505, the electron may have sufficient energy to create positive ions through electron impact ionization. Accordingly, it is possible to form both positive and negative ions similar to the process that takes place with radioactive 63Ni ionization sources. By controlling the voltage applied across the conductor plates and/or the gap height, it is possible to accelerate the electrons to a moderate level where a soft plasma forms but avalanche processes do not occur. The ions are formed at atmospheric pressure levels inside the gap 510, but the device may be configured for lower and higher pressures for other applications, ranging from sub-millitorr to a few atmospheres of pressure.

There are several issues to consider when using micro and nano-structures for electron field emission. For example, given that the emission structures 505 will potentially operate in air or other gaseous environments, the tips of the emitters are susceptible to gas adsorption and the formation of physical and chemical bonds with the gas molecules. Accordingly, subsequent changes in work function and aspect ratio of the structures 505 are possible. Such physical and chemical changes may lead to degradation in the electron emission properties of the structures 505. In general, however, carbon nanotubes may inhibit these effects given that the carbon nanotube structures are relatively inert compared to most metals (i.e., oxide layers will not form on carbon nanotube surfaces). Additionally, inert gases including, for example, argon or helium, may be used to reduce such physical and chemical changes. Other gases, such as nitrogen, may be used as well.

In some cases, when a very high voltage is applied between electrodes, ions bombard the field emission structures 505 causing erosion damage. This erosion damage is mainly due to water molecules or oxygen ions that attach to the carbon nanotube material and convert it to carbon monoxide or carbon dioxide through chemical reaction, thus leading to a reduction in emitter lifetime. This is particularly true in high vacuum environments in which the ions have high kinetic energy upon impact with the field emission structures. However, if the ionization source 500 is operated at atmospheric pressure, the ions will experience high collision rates with other gas molecules prior to coming into contact with the field emission structures 505. Accordingly, ion erosion effects can be reduced. In addition, inert gas environments may also be used to reduce erosion of the field emission structures 505 due to chemical reaction.

When using multi-walled carbon nanotubes as the field emission structure, the density of nanotubes on the conductor plate may be controlled. In some cases, high densities of nanotubes reduce the overall effectiveness of the field emission structure, whether in air or in vacuum.

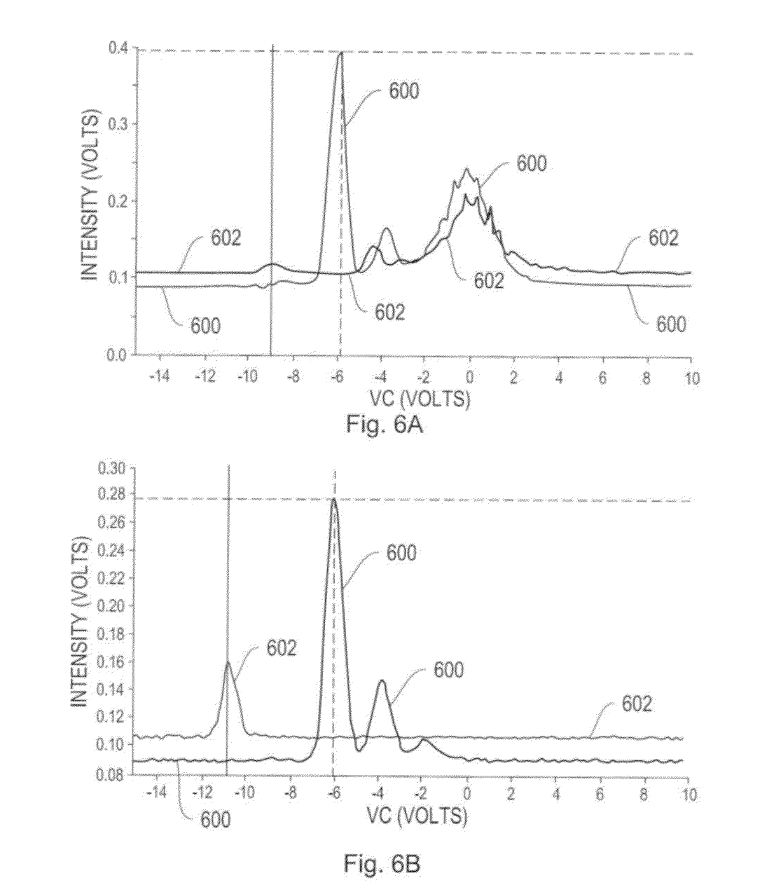

FIG. 6A shows a plot of positive and negative spectra from an ionization source that include carbon nanotubes as the field emission structures according to an illustrative embodiment of the invention. The spectra are obtained from a differential mobility spectrometer coupled to the ionization source 500 that includes carbon nanotubes as the electron field emission structures. The spectra include positive (data line 600) and negative (data line 602) ions generated from a carrier gas that includes only air ionized by the device 500.

FIG. 6B shows a plot of comparison spectra in which the ionization source utilizes radioactive 63-Ni instead of carbon nanotube field emission structures according to an illustrative embodiment of the invention. The spectra shown in FIG. 6B also includes positive (data line 600) and negative (data line 602) ions.

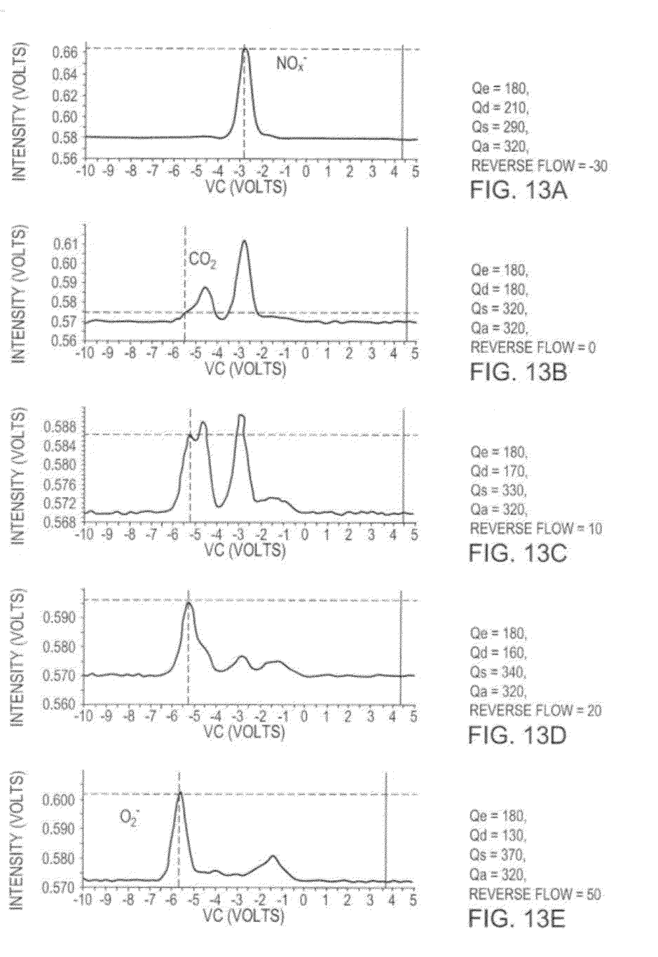

A comparison of the positive ion spectra shows that similar positive ion species are generated by both the carbon nanotube source and the radioactive 63-Ni source. In addition, a comparison of the negative ion spectra shows that both ionization sources produce negative oxygen ion species (oxygen ions detected at VC=−9 V for carbon nanotube source and at VC=−11 V for 63-Ni source), which enable the ionization of methyl salicylate (MS) molecules, if introduced as a sample gas. In contrast, however, when operating in the negative mode, the carbon nanotube ion source produces additional undesirable ion species, such as NO2- and NO3-ions (Nitrous oxide ions detected at VC=−4.5 V and 0 V, see FIG. 13A) that are not produced by the radioactive 63-Ni source.

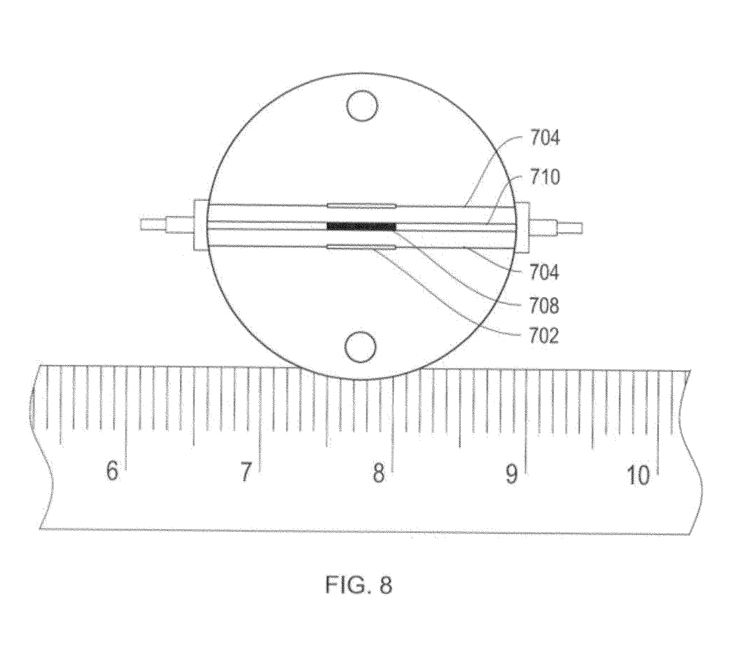

FIG. 7A and 7B show two perspectives of a cross-sectional diagram of an Insulating Barrier Ion (IBI) source assembly 700 according to an illustrative embodiment of the invention. An IBI is another example of an ionization source 102 that can be implemented in the ion-based analysis system 100 of FIG. 1. The IBI source is low power, has a long lifetime, is inexpensive and provides a spectrometer signal. In one embodiment, the IBI system 700 consists of electrodes 702 connected to an AC voltage source 706 for applying a potential to the electrodes, dielectric insulators 704, spacers 710, and a gas channel 708 formed between the insulators and the spacers. The AC voltage source 706 may be driven as depicted in FIG. 3C. Typical AC pulse frequency are between 20,000 Hz to 100,000 Hz although values outside this range may also work. Typical pulse repetition rates are between 100 Hz and 10,000 Hz although other values outside this range may also work. The electrodes 702 are separated from the gas channel 708 by dielectric sheets. Gas flows through the channel 708 formed by the two dielectric sheets 704 held apart by insulating spacers 710. The electric fields in the gas channel, created by the electrodes, cause the gas to electrically discharge and create ions. The ions make up plasma in the gas flowing through the gas channel 708. The ions formed in the gas channel 708 may then be carried out of the device 700 by the gas flow for analysis. FIG. 8 shows one embodiment of the IBI assembly.

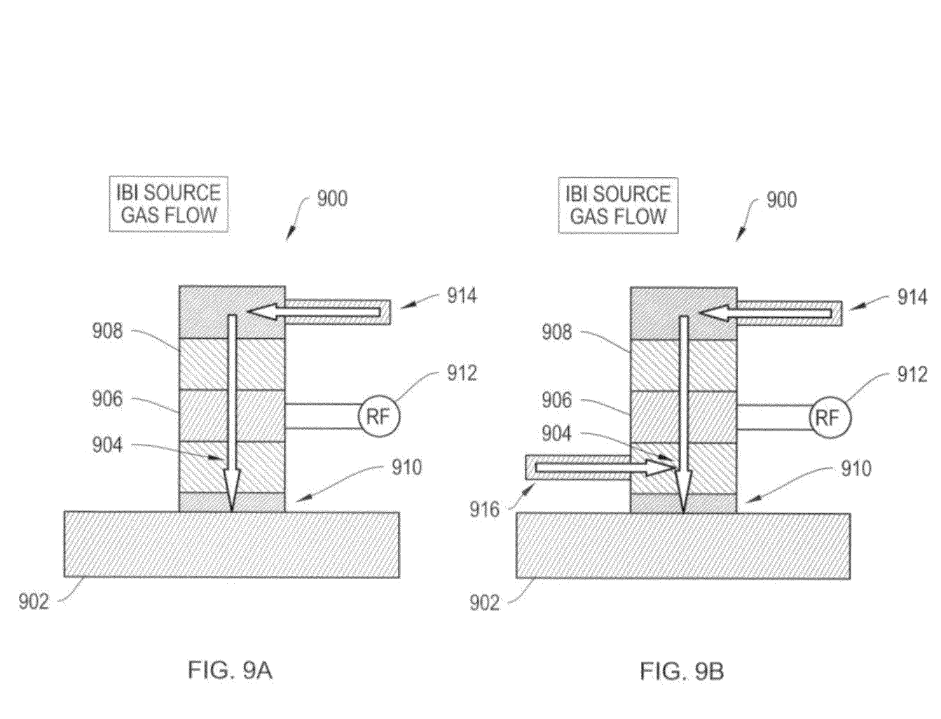

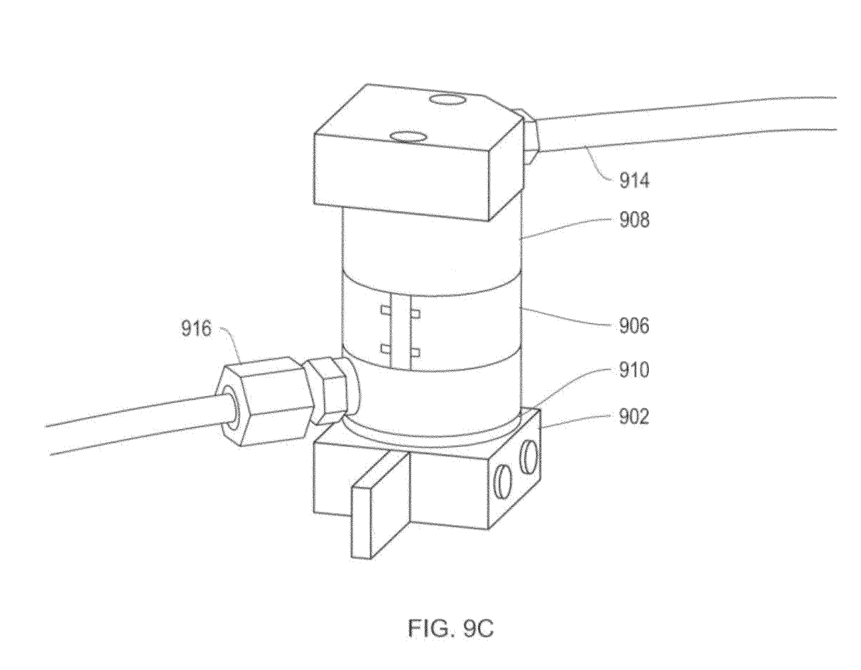

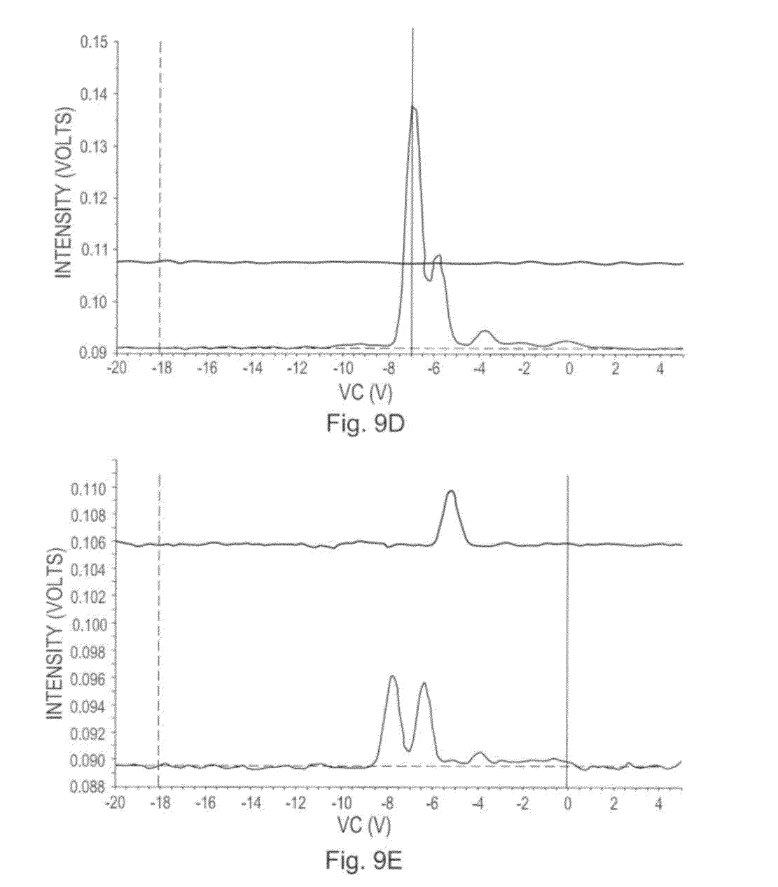

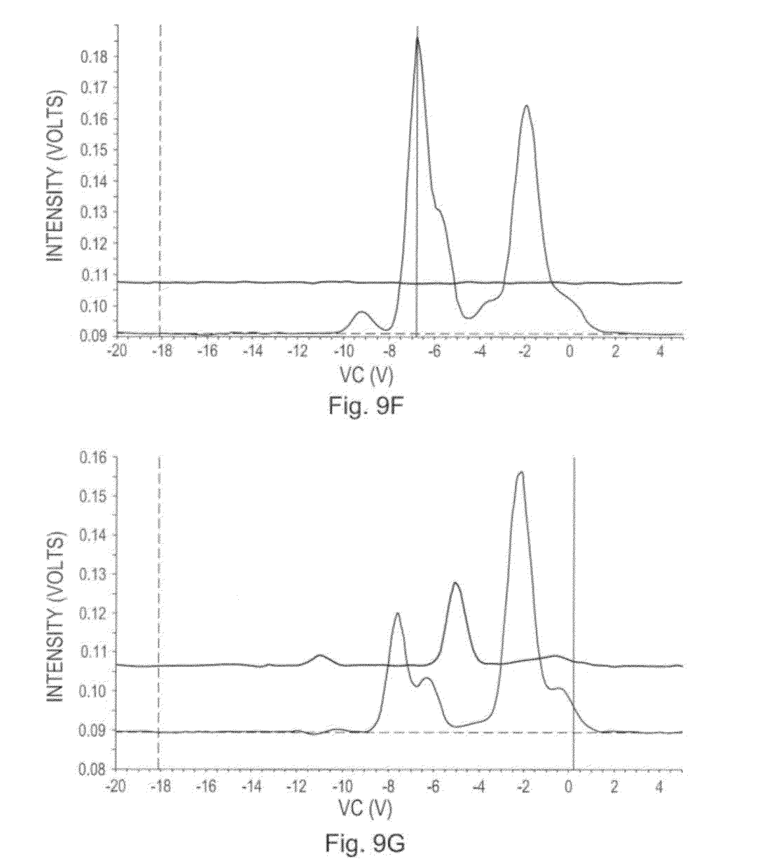

FIG. 9A and 9B show two diagram examples of an Insulating Barrier Ion source system 900 coupled with a differential mobility spectrum analyzer 902 according to illustrative embodiments of the invention. In one embodiment of the invention, the IBI system is made up of a transport gas inlet 914, a voltage source 912 for creating an electric field within the IBI, insulating spacers 908, a metal aperture 910, the IBI ionizer 906 as described with respect to FIGS. 7-8, gas flow 904, and a DMS unit 902. In one implementation, shown in FIG. 9A, the gas flow 904, which may consist of a transport gas, analytes or a combination of both, is inserted at the top of the device at the transport gas inlet 914 allowing gas to flow through the IBI. The ions are then carried into the DMS unit 902 for analysis of the ion spectra. In another embodiment, shown in FIG. 9B, the analyte is introduced after the IBI ionizer at the analyte inlet 916. In this case, analyte ions are created by interaction of analyte neutral molecules with reactant ions that are formed in the transport gas passing through the IBI plasma source. The transport gas then transports the formed analyte ions into the DMS 902. FIG. 9C shows a view of the assembly as diagramed in FIG. 9B.

FIG. 9D shows a plot depicting the spectra of a transport gas consisting of N₂, according to an illustrative embodiment of the invention. FIG. 9E shows a plot depicting the spectra of a transport gas consisting of air, according to an illustrative embodiment of the invention. The plots display the spectra of carrier gasses N₂ and air without mixed analytes and are obtained using the setup of FIG. 9A. This data was taken with an ion differential mobility spectrometer (DMS) equipped with a IBI ionizer, as described with respect to FIGS. 7-9. FIG. 9F shows a plot depicting the spectra of a transport gas consisting of N₂ mixed with methyl salicylate, according to an illustrative embodiment of the invention. FIG. 9G shows a plot depicting the spectra of a transport gas consisting of air mixed with methyl salicylate, according to an illustrative embodiment of the invention. The setup described in FIGS. 9B and 9C was used to introduce methyl salicylate after the transport gas has passed through the ionizer.

As demonstrated by the plots, the spectra signature of the added analyte, methyl salicylate, is clearly depicted alongside the spectra of Air and N₂, indicating the efficacy of the IBI source used in an ion-based analyzer.

FIG. 10A shows an exemplary ion-based analyzer employing reverse flow control according to an illustrative embodiment of the invention. In one embodiment, the ion-based analyzer system 1000 comprises an ion source 1002 inside the discharge chamber 1004, an exhaust channel for exhaust gas 1006, a discharge gas inlet for discharge gas 1008, a sample gas inlet for the sample gas 1010 to flow into the ionization chamber 1014, an analyzed gas channel where the sample 1012 flows to the analyzer 1016. The setup may also include a voltage source 1018 to apply potential to the electrodes 1024 and 1026 to create an electric field within the discharge chamber 1004 and the ionization chamber 1014. The setup may also include a controller 1022 to control the flow rate of the exhaust gas 1006, the discharge gas 1008, the sample gas 1010, the analyzed gas 1012, and subsequently the reverse flow 1020, where the reverse flow consists of the flow between the ionization chamber 1014 and the discharge chamber 1004. The controller 1022 may include a processor and/or microcontroller. The processor may utilize software and/or firmware function or applications to regulate the aggregate flow into an out of the discharge chamber. The controller 1022 may interface with one or more flow sensors capable of measuring any one of the flows into, through, or out of the system 1000. The controller 1022 may interface with one or more flow valves, actuators, orifices, and/or flow control elements to effect to control of any one of the flows. The controller 1022 may control any one or combination of the flows to regulate the flow rate and/or flow direction into and/or out of the chamber 1004.

In operation, the ion-based analyzer system 1000 may employ an ion source 1002. The ion source 1002 may include, without limitation, a carbon nanotube ion source, CGD ion source, cross-wire ion source, DBD ion source, or IBI source as previously described, to create a negative discharge in the discharge chamber 1004. The discharge gas flow 1008 is directed toward the exhaust channel 1006 at the top of the diagram. The electric field created between electrodes 1024 and 1026 is directed toward the analyzer 1016. The analyzer 1016 may comprise at least one of a DMS, IMS, MS, ion mobility based filter, and mass-to-charge filter as previously described. The gas flow balance can be controlled according to the equation: Qa=Qs+Qd−Qe, where Qa is the analyzed gas flow, Qs is the sample flow, Qd is the discharge gas flow and Qe is the exhaust flow. The reverse flow 1020 may also be controlled by controlling the exhaust flow 1006 and the discharge gas flow 1008 according to equation: Reverse Flow=Qe−Qd. The controller 1022 may control the gas flow balance and/or discharge gas flow rate in response to a software application running on a processor of the controller.

FIG. 10B shows an example embodiment of how an ion based analyzer employing reverse flow control as described in FIG. 10A, may utilize any type of plasma generator (wire-based, CNT, or IBI) as an ion source, and DMS is as an analyzer. In the case of a carbon nanotube (CNT) ionizer, plasma is created using a carbon nanotube source, then filtered and detecting using DMS techniques. The wire-based, CNT or IBI ionizers may be assembled in a grid formation in order to create both an electric field and allow gas to flow.

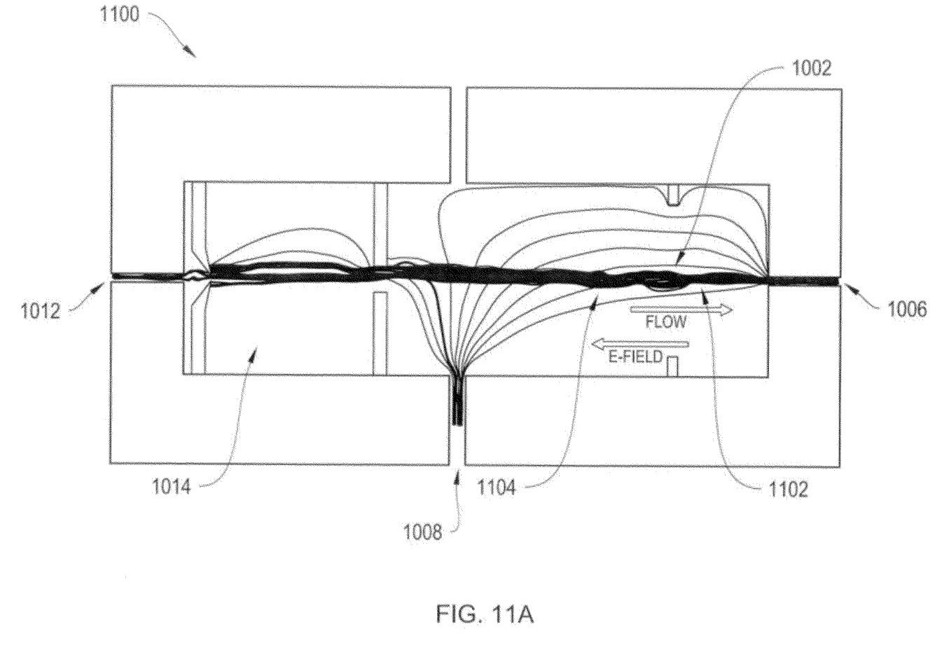

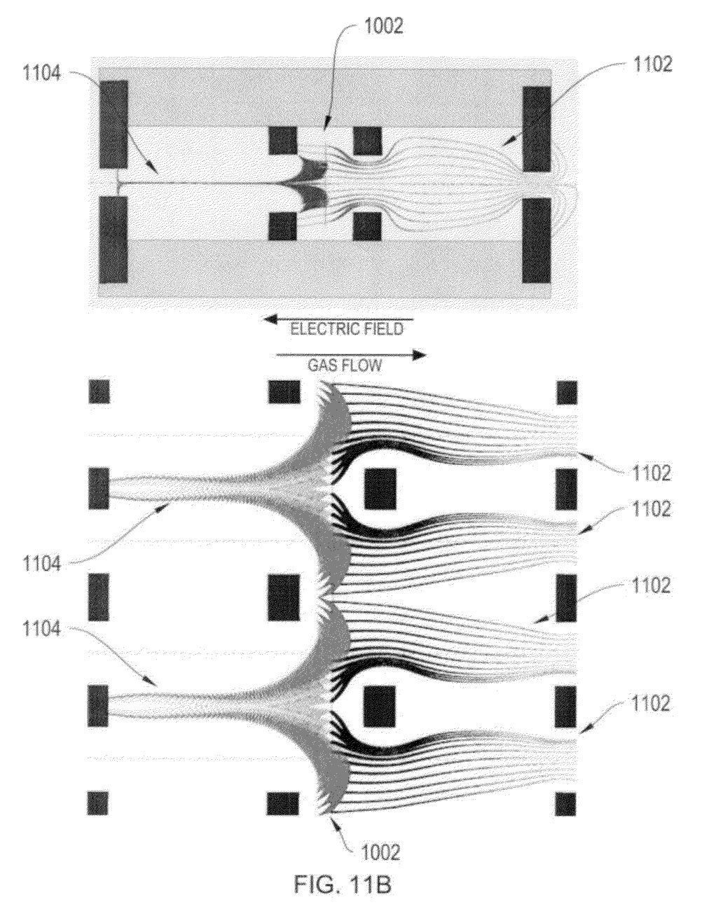

FIG. 11A shows a simulation of ion flow in an ion-based analyzer system 1100 employing reverse flow control as described in FIGS. 10A and 10B. Gas flow is directed to the right from the discharge gas inlet 1008 toward the exhaust channel 1006. A potential is applied to the electrodes to create an electric field directed toward the analyzer 1016, as described with respect to FIG. 10A. The ion source 1002 causes ionization of the discharge gas 1008. As a result of the gas flow, a majority of the heavy ions and neutrals 1102 (e.g. NOx and ozone) are purged to the right toward the exhaust gas channel 1006. In one embodiment, the velocity of movement of charged particles that are under the effect of an electric field are proportional to the coefficient of mobility (K) and electric field (E) as defined by \vec{Θ} =K*\vec{E}. Computer modeling shows that charged light particles from plasma 1104 (e.g. electrons and very light ions) can be driven against the counter gas flow to the left by the electric field toward the ionization chamber 1014. As illustrated in FIG. 11A, ion movement against counter gas flow occurs when the coefficient of mobility of a particle is higher than 5 cm²s⁻¹V⁻¹ (Ko>5 cm²s⁻¹V⁻¹). These light charges may be used for oxygen-type ionization within the ionization chamber 1014. Other particles, such as NOx, having mobility coefficient values of, for example, Ko=2-3 cm²s⁻¹V⁻¹, move in the counter gas flow direction toward the exhaust 1006, even in the presence of an electric field. Thus, the combination of the electric field and reverse flow advantageously suppress the introduction of NOx contaminants into the ionization chamber 1014.

FIG. 11B shows two simulations of alternative implementations of an ion-based analyzer employing reverse flow control according to illustrative embodiments of the invention. The models of FIG. 11B function in a similar fashion as described above in regard to FIG. 11A, but employ two grids and are modeled using CNT and IBI ionizers.

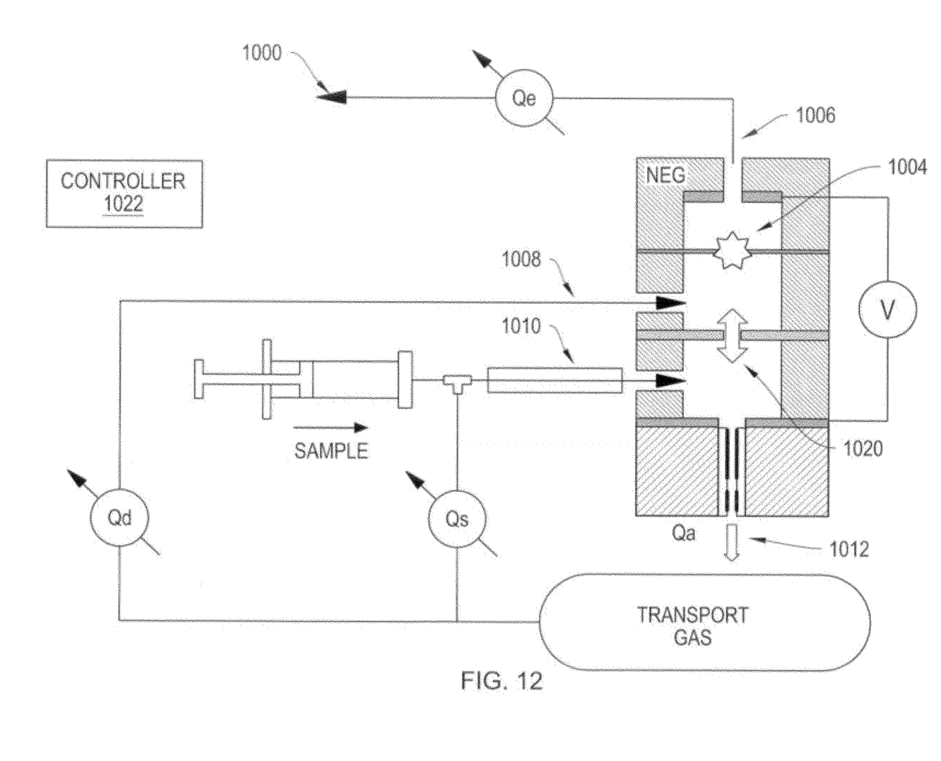

FIG. 12 shows an experimental setup where reverse flow is controlled within an ion-based analyzer according to an illustrative embodiment of the invention. Reverse flow is a key parameter for creating desirable ion samples using negative non-radioactive ionizers. As depicted in FIG. 12, the discharge gas flow 1008 and the exhaust flow 1006 may be controlled to optimize the reverse flow 1020 according to the equation Reverse Flow=Qe−Qd, as previously described. The discharge flow 1008 (Qd) and the exhaust flow 1006 (Qe) may either be controlled manually, or automatically by a controller 1022. The analysis flow 1012 can then be controlled by the equation: Qa=Qs−Reverse Flow. The sample flow 1010 (Qs) may be controlled manually, or automatically by a controller 1022.

FIG. 13A-13E show plots comparing spectra with varying reverse flow rate. In each of the plots, the flow rates (Qe, Qd, Qs, Qa) are changed to provide a corresponding reverse flow rate. The analyzed gas flow rate is held constant throughout. The spectra are produced using a DMS system as previously described. The DMS peaks correspond to NOx ions at ˜3V, O₂⁻ions at ˜5V and CO₂ at ˜4V. For example, FIG. 13A shows the

DMS spectra correlating primarily to NOx ions. FIG. 13C shows DMS spectra correlating to NOx, O₂⁻and CO₂ ion species. The plots demonstrate that as the reverse flow rate increases, as a result of controlling the other flow rate parameters of the system, ionization efficiency increases and desirable O₂⁻ion species become more abundant than undesirable NOx ion species.

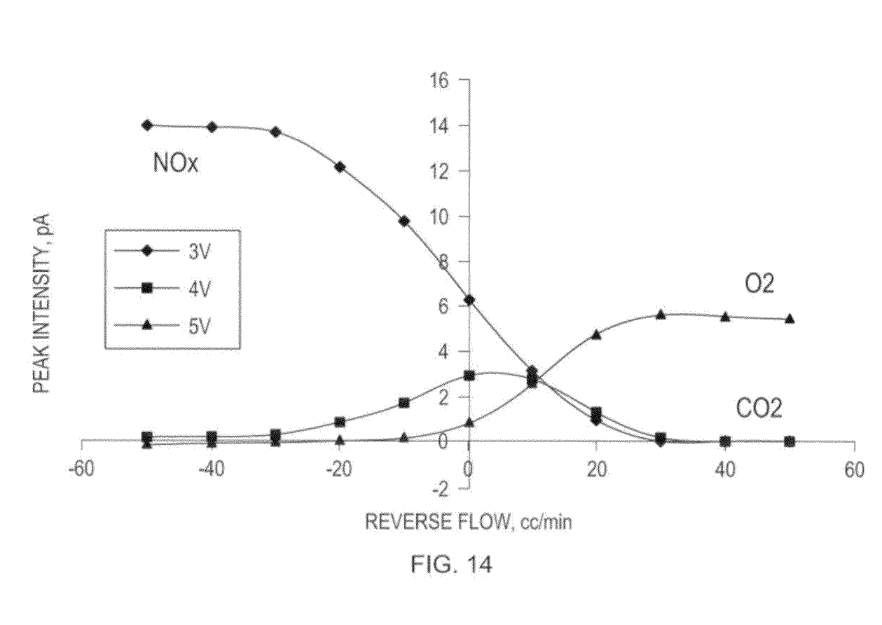

FIG. 14 shows a plot of negative reactant ion evolution in dependence of reverse flow rate. Again, the plot demonstrates that as reverse flow rate increases, the intensity of desirable O₂⁻ion species increases, while the intensity of undesirable ion species decreases.

While this invention has been particularly shown and described with references to preferred embodiments thereof, it will be understood by those skilled in the art that various changes in form and details may be made therein without departing from the scope of the invention encompassed by the appended claims.

What is Claimed is:

1) An ion-based analyzer comprising:
an ion generation chamber including a non-radioactive ion source for generating ions, the ion generation chamber including a first transport gas inlet for providing a first transport gas flow,
a sample ionization chamber including an ion inlet for receiving the ions and a sample inlet for receiving a sample, wherein a portion of the sample is ionized to form sample ions, the sample ionization chamber including a second transport gas inlet for providing a second transport gas flow
a controller for controlling the flow rate of at least one of the first transport gas flow and the second transport gas flow to control the transport gas flow through the ion inlet
an ion-based filter, in communication with the sample ionization chamber, for filtering the sample ions, and
a detector for detecting the filtered sample ions.

2) The analyzer of claim 1, wherein controlling the transport gas flow through the ion inlet includes controlling the direction and flow rate of the gas flow through the ion inlet.

3) The analyzer of claim 2, wherein the transport flow through the ion inlet includes a reverse transport flow such that the transport flow substantially opposes the ion flow.

4) The analyzer of claim 3, wherein the ion flow is directed by an electric field.

5) The analyzer of claim 1, wherein the controller includes a processor.

6) The analyzer of claim 1, wherein the transport gas substantially includes an inert gas.

7) The analyzer of claim 1, wherein the transport gas substantially includes air.

8) The analyzer of claim 1, wherein the ion source includes a carbon nanotube.

9) The analyzer of claim 1, wherein the ion source includes a capacitive gas discharge ion source.

10) The analyzer of claim 1, wherein the ion source includes a cross-wire ion source.

11) The analyzer of claim 1, wherein the ion source includes a dielectric barrier discharge source.

12) The analyzer of claim 1, wherein the ion source includes an Insulating Barrier Ionizer source

13) The analyzer of claim 1, wherein the ion source substantially produces negative ions.

14) The analyzer of claim 1, wherein the ion source substantially produces positive ions.

15) The analyzer of claim 1, wherein the ion source produces positive and negative ions.

16) The analyzer of claim 1, wherein the ion-based filter includes at least one of a Differential Mobility Spectrometer, Ion Mobility Spectrometer, Mass Spectrometer, ion mobility based filter, and mass-to-charge based filter.

17) A method for analyzing a sample comprising:
flowing a first transport gas through a transport gas inlet to an ion generation chamber,
generating ions in the generation chamber using a non-radioactive ion source,
receiving ions in a sample ionization chamber from an ion inlet
receiving a sample in a sample ionization chamber from a sample inlet,
ionizing a portion of the sample to form sample ions,
flowing a second transport gas through a second transport gas inlet to a sample ionization chamber,
controlling the flow rate of at least one of the first transport gas flow and the second transport gas flow to control the transport gas flow through the ion inlet,
filtering the sample ions using an ion-based filter in communication with the sample ionization chamber, and
detecting the filtered sample ions.

18) The method of claim 17, wherein controlling the transport gas flow through the ion inlet includes controlling the direction and flow rate of the gas flow through the ion inlet.

19) The method of claim 18, wherein the transport flow through the ion inlet includes a reverse transport flow such that the transport flow substantially opposes the ion flow.

20) The method of claim 19, wherein the ion flow is directed by an electric field.

21) The method of claim 17, wherein the controller includes a processor.

22) The method of claim 17, wherein the transport gas substantially includes an inert gas.

23) The method of claim 17, wherein the transport gas substantially includes air.

24) The method of claim 17, wherein the ion source includes a carbon nanotube.

25) The method of claim 17, wherein the ion source includes a capacitive gas discharge ion source.

26) The method of claim 17, wherein the ion source includes cross-wire ion source.

27) The method of claim 17, wherein the ion source includes a dielectric barrier discharge source.

28) The method of claim 17, wherein the ion source includes an Insulating Barrier Ionizer source

29) The method of claim 17, wherein the ion source substantially produces negative ions.

30) The method of claim 17, wherein the ion source substantially produces positive ions.

31) The method of claim 17, wherein the ion source produces positive and negative ions.

32) The method of claim 17, wherein the ion-based filter includes at least one of a Differential Mobility Spectrometer, Ion Mobility Spectrometer, Mass Spectrometer, ion mobility based filter, and mass-to-charge based filter.

33) An ion source comprising:
a non-radioactive ionizer for generating ions,
a first transport gas flow for flowing a portion of the ions toward an ion analyzer,
a second transport gas flow for flowing a second portion of the ions away from the ion analyzer, and
a controller for controlling an adjustable flow rate of at least one of the first transport gas flow and the second transport gas flow.

34) The ion source of claim 33, wherein the ionizer includes at least one of a carbon nanotube, Capacitive Gas Discharge ionizer, Cross-wires ionizer Dielectric Barrier Discharge ionizer, and Insulating Barrier Ionizer.

35) The ion source of claim 34, wherein the ionizer substantially generates negative ions.

36) The ion source of claim 33, comprising a sample inlet for receiving a sample, wherein the sample is ionized by the ionizer into sample ions.

37) The ion source of claim 33, comprising an outlet for outputting a portion of the sample ions.

38) The ion source of claim 37, wherein the outlet is coupled to at least one of a Differential Mobility Spectrometer, Ion Mobility Spectrometer, Mass Spectrometer, ion-mobility based analyzer, and mass-to-charge based analyzer.
